(19) United States
(12) Patent Application Publication
(10) Pub. No.: US 2026/0027896 A1
(43) Pub. Date: Jan. 29, 2026

(54) HOLOGRAPHIC INTERFACE CONTROL FOR A VEHICLE

(71) Applicant: GM GLOBAL TECHNOLOGY OPERATIONS LLC, DETROIT, MI (US)

(72) Inventors: Kyle Reimer, Royal Oak, MI (US); Joseph F. Szczerba, Grand Blanc, MI (US); Fatemeh Abolfazli Zargar, Birmingham, MI (US); Bochen Peng, Detroit, MI (US); Kai-Han Chang, Madison Heights, MI (US)

(21) Appl. No.: 18/782,479

(22) Filed: Jul. 24, 2024

(51) Int. Cl. B60K 35/22; B60K 35/81

(52) U.S. Cl. CPC B60K 35/22; B60K 35/81; B60K 2360/21; B60K 2360/29

(57) ABSTRACT

Aspects of the disclosure include a method for controlling a vehicle via a holographic interface. Aspects include detecting a request, by an occupant of the vehicle, to display a holographic user interface and instructing a holographic display device to display the holographic user interface. Aspects also include detecting an interaction between the occupant and the holographic user interface, identifying a desired action for the vehicle based on the interaction, and instructing the vehicle to perform the desired action.

### INTRODUCTION

The subject disclosure relates to methods and devices for controlling the operation of a vehicle, and particularly to a holographic interface control system for a vehicle.

In general, vehicles have a plurality of systems that occupants of the vehicle may wish to control while inside the vehicle. Such systems include the propulsion, braking, and steering systems of the vehicle as well as infotainment systems, heating and air-conditioning systems, and the like. Traditional vehicles utilize various different controls for each of these various systems. Often the controls for certain functions are only located in a specific area of the vehicle, such as the steering wheel, the accelerator, and the brake pedal. In autonomous or semi-autonomous vehicles, it may be desirable to remove one or more traditional vehicle control systems such as the steering wheel, the accelerator, and the brake pedal.

### SUMMARY

In one exemplary embodiment, a method for controlling a vehicle is provided. The method includes detecting a request, by an occupant of the vehicle, to display a holographic user interface, instructing a holographic display device to display the holographic user interface, and detecting an interaction between the occupant and the holographic user interface. The method also includes identifying a desired action for the vehicle based on the interaction and instructing the vehicle to perform the desired action.

In addition to the one or more features described, the desired action is a modification of one or more of a direction and a speed of travel of the vehicle and wherein the method further comprises performing a safety check for the desired action and only instructing the vehicle to perform the desired action based on a determination that the safety check has been successfully completed.

In addition to the one or more features described, the method also includes instructing the holographic display device to stop displaying the holographic user interface based on a determination that no interaction between the occupant and the holographic user interface is detected for at least a predetermined time period.

In addition to the one or more features described, the holographic user interface is a scaled down representation of the vehicle.

In addition to the one or more features described, the method also includes providing haptic feedback to the occupant based on the detection of the interaction.

In addition to the one or more features described, the request is a gesture made by the occupant of the vehicle that is observed by a camera disposed in an interior of the vehicle.

In addition to the one or more features described, the interaction is a gesture made by the occupant of the vehicle that is observed by a camera disposed in an interior of the vehicle.

In addition to the one or more features described, the request is a voice command by the occupant of the vehicle that is captured by a microphone disposed in an interior of the vehicle.

In addition to the one or more features described, the desired action is one of an adjustment to a seating position of a seat of the occupant of the vehicle, an adjustment to a heating and cooling system of the vehicle, and an adjustment to an infotainment system of the vehicle.

In one exemplary embodiment, a method for controlling a vehicle is provided. The method includes detecting a request, by an occupant of the vehicle, to display a holographic user interface, instructing a holographic display device to display the holographic user interface comprising a scaled down representation of the autonomous vehicle, detecting an interaction between the occupant and the holographic user interface, and identifying a desired action for the autonomous vehicle based on the interaction wherein the desired action is a modification of one or more of a direction and a speed of travel of the autonomous vehicle. Based on a determination that the autonomous vehicle can safely perform the desired action, the method includes instructing the vehicle to perform the desired action. Based on a determination that the autonomous vehicle can not safely perform the desired action, the method includes providing feedback to the occupant of the vehicle that the desired action can not be performed.

In addition to the one or more features described, the method further includes instructing the holographic display device to stop displaying the holographic user interface based on a determination that no interaction between the occupant and the holographic user interface is detected for at least a predetermined time period.

In addition to the one or more features described, the feedback is haptic feedback provided to the occupant.

In addition to the one or more features described, the feedback is a change made to an appearance of the holographic user interface.

In addition to the one or more features described, the request is a gesture made by the occupant of the vehicle that is observed by a camera disposed in an interior of the vehicle.

In addition to the one or more features described, the interaction is a gesture made by the occupant of the vehicle that is observed by a camera disposed in an interior of the vehicle.

In addition to the one or more features described, the request is a voice command by the occupant of the vehicle that is observed by a microphone disposed in an interior of the vehicle.

In one exemplary embodiment, a vehicle is provided. The vehicle includes a plurality of sensors configured to monitor a movement of an occupant of the vehicle, a holographic display device configured to display a holographic user interface, and a processing system configured to receive data from the plurality of sensors. The processing system is configured to execute a computer program that includes instructions to detect a request, by the occupant of the vehicle, to control a system of the vehicle, instruct, based on the request, the holographic display device to display the holographic user interface, wherein a form of the holographic user interface is determined based on the system of the vehicle to be controlled, detect, via one or more of the plurality of sensors, an interaction between the occupant and the holographic user interface, identify a desired action for the system of the vehicle based on the interaction, and instruct the vehicle to perform the desired action.

In addition to the one or more features described, the system of the vehicle is one of a drive system of the vehicle, an infotainment system of the vehicle, and a heating and cooling system of the vehicle.

In addition to the one or more features described, the request is a gesture made by the occupant of the vehicle that is observed by a camera disposed in an interior of the vehicle and wherein the system of the vehicle is determined based on a type of the gesture.

In addition to the one or more features described, the desired action is a modification of one or more of a direction and a speed of travel of the vehicle and wherein the instructions further comprise instructions to perform a safety check for the desired action and only instructing the vehicle to perform the desired action based on a determination that the safety check has been successfully completed.

The above features and advantages, and other features and advantages of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 is a perspective view of a vehicle configured in accordance with one or more embodiments;

FIG. 2 is a block diagram of a vehicle configured in accordance with one or more embodiments;

FIGS. 3A and 3B are schematic diagrams of a holographic user interface in accordance with one or more embodiments;

FIGS. 4A and 4B are schematic diagrams of a holographic display device configured to generate a holographic user interface in accordance with one or more embodiments;

FIG. 5 is a flowchart of a method for controlling the operation of a vehicle using a holographic user interface in accordance with one or more embodiments; and

FIG. 6 is a flowchart of another method for controlling the operation of a vehicle using a holographic user interface in accordance with one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

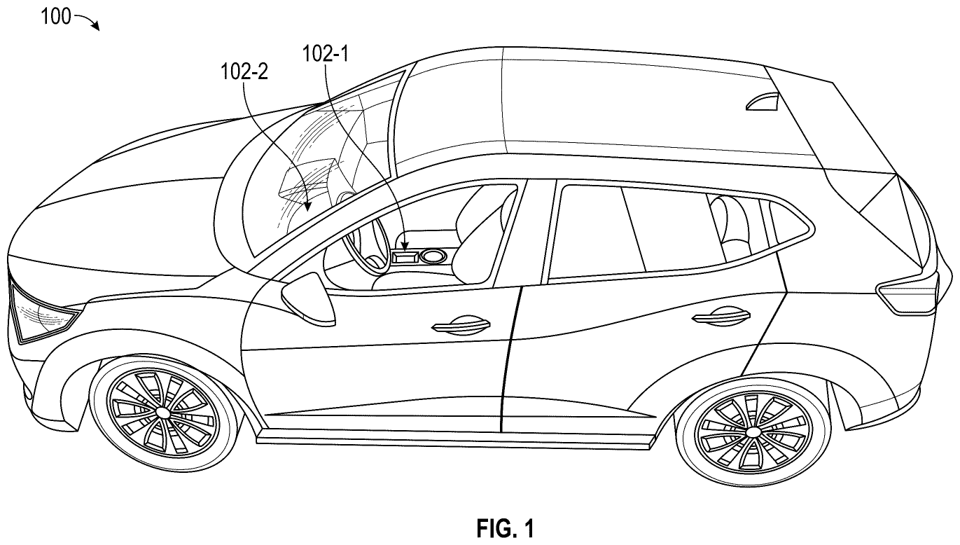

Referring now to FIG. 1, a vehicle 100, in accordance with an exemplary embodiment is shown. The vehicle 100 may be an autonomous vehicle, a semi-autonomous vehicle, or a vehicle with traditional propulsion/steering controls. In exemplary embodiments, the vehicle 100 includes one or more holographic display devices 102-1 and 102-2, referred to collectively herein as holographic display devices 102. In exemplary embodiments, the holographic display devices 102 are configured to cause a holographic user interface to be displayed to an occupant of the vehicle. In exemplary embodiments, the occupant can control the operation of one or more systems of the vehicle 100 via an interaction with the holographic user interface. In exemplary embodiments, the holographic display devices 102 can be placed in a variety of interior locations in the vehicle 100.

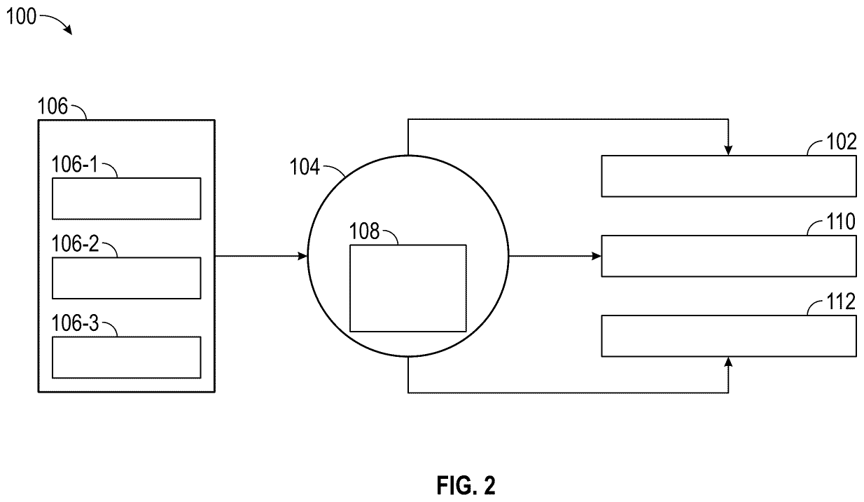

Referring now to FIG. 2, a block diagram of vehicle 100 in accordance with an exemplary embodiment is shown. The vehicle 100 includes a holographic display device 102, a processing system 104, a plurality of sensors 106, holographic control algorithms 108, a feedback generator 110, and one or more vehicle control systems 112. In exemplary embodiments, the processing system 104 includes one or more of a general-purpose processor, a field programmable gate array (FPGA), an application-specific integrated circuit (ASIC), or the like. The processing system 104 is configured to receive input data from a plurality of sensors 106 that are disposed in, or on, the vehicle 100. The sensors 106 include but are not limited to light detection and ranging (LiDAR) sensors 106-1, cameras 106-2, and microphones 106-3.

In exemplary embodiments, the processing system 104 is configured to monitor an occupant of the vehicle 100 via the sensors 106 and to detect a request by the occupant of the vehicle 100 for a holographic user interface to be displayed by a holographic display device 102. In one embodiment, the movement of an occupant of the vehicle 100 is monitored by one or more cameras 106-2 and based on detecting a predetermined movement, the processing system 104 instructs the holographic display device 102 to display a holographic user interface. In another embodiment, the voice of an occupant of the vehicle 100 is monitored by one or more microphones 106-3 and based on detecting a predetermined command phrase, the processing system 104 instructs the holographic display device 102 to display a holographic user interface. In an exemplary embodiment, the vehicle 100 includes a plurality of holographic display devices 102 that are disposed throughout the vehicle 100 and are used to display holographic user interfaces to occupants of the vehicle 100 seated in different locations of the vehicle 100.

In exemplary embodiments, the processing system 104 is configured to execute one or more holographic control algorithms 108. The holographic control algorithms 108 are executed by the processing system 104 to control the operation of the holographic display device 102, the feedback generator 110, and the vehicle control systems 112. In exemplary embodiments, the holographic control algorithms 108 include a mapping between the detected movements and voice commands of an occupant of the vehicle 100 and a type of holographic user interface to be displayed. For example, a first movement or voice command may cause the processing system 104 to instruct the holographic display device 102 to display a holographic user interface for controlling a movement of the vehicle 100 and a second movement or voice command may cause the processing system 104 to instruct the holographic display device 102 to display a holographic user interface for controlling an infotainment system of the vehicle 100.

In exemplary embodiments, the sensors 106 are further configured to detect an interaction between the occupant of the vehicle 100 and a holographic user interface being displayed by the holographic display device 102. For example, a camera 106-2 may detect that the occupant has placed their hand on a portion of the holographic user interface and has made a gesture to interact with the holographic user interface being displayed by the holographic display device 102. In exemplary embodiments, the processing system 104 instructs the holographic display device 102 to modify the holographic user interface being displayed based on the detected interaction. For example, the holographic display device 102 may modify the orientation of the holographic user interface, the color of the holographic user interface, and the items displayed by the holographic user interface.

In exemplary embodiments, the processing system 104 is also configured to instruct the feedback generator 110 to provide feedback to the occupant of the vehicle based on the detected interaction between the occupant and the holographic user interface being displayed by the holographic display device 102. In one embodiment, the feedback generator 110 is configured to provide haptic feedback to the occupant of the vehicle using ultrasonic or haptic pulses. For example, the processing system 104 may instruct the feedback generator 110 to provide haptic feedback to the occupant of the vehicle to indicate that the interaction between the occupant and the holographic user interface has been received.

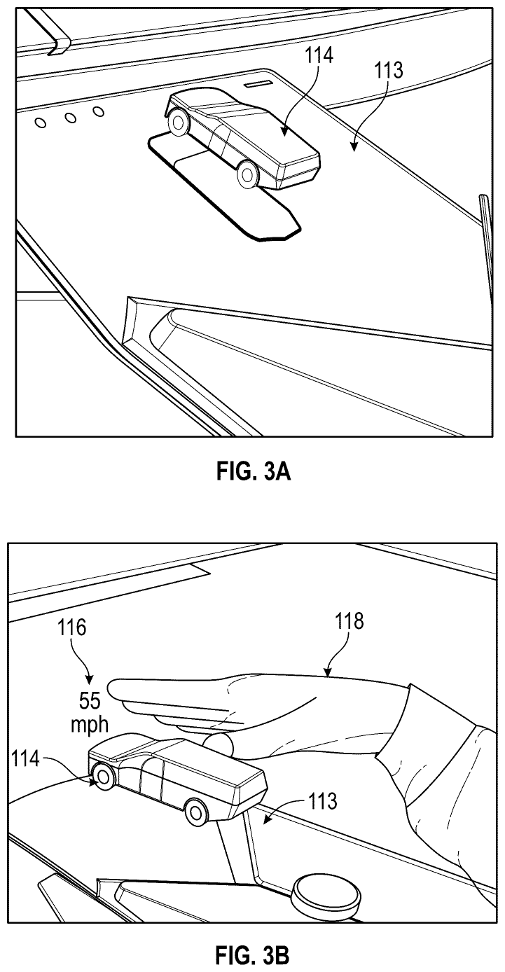

Referring now to FIGS. 3A and 3B, schematic diagrams of a holographic user interface 114 in accordance with one or more embodiments are shown. In one embodiment, a holographic user interface 114 is displayed above a center console 113 of a vehicle. In the illustrated embodiment, the holographic user interface 114 is a scaled down representation of the vehicle 100. The holographic user interface 114 may also display one or more parameters 116 of the operation of the vehicle 100, such as the speed of the vehicle 100. As best shown in FIG. 3B, an occupant of the vehicle may interact with the holographic user interface 114 using their hand 118. In one embodiment, the occupant of the vehicle may increase/decrease the speed of the vehicle 100 by moving holographic user interface 114 forward or backward. In another embodiment, the occupant of the vehicle may indicate a desire for the vehicle to switch lanes by swiping or nudging the holographic user interface 114 to the left or right.

In exemplary embodiments, the holographic display device 102 may utilize various techniques to generate and display the holographic user interface 114. In exemplary embodiments, a lenticular array or parallax barrier disposed in the vehicle, such as in the center console 113 of the vehicle, can be used to generate and display the holographic user interface 114. In other embodiments, the holographic display device 102 is configured to generate the holographic user interface 114 on the retina of an occupant of the vehicle.

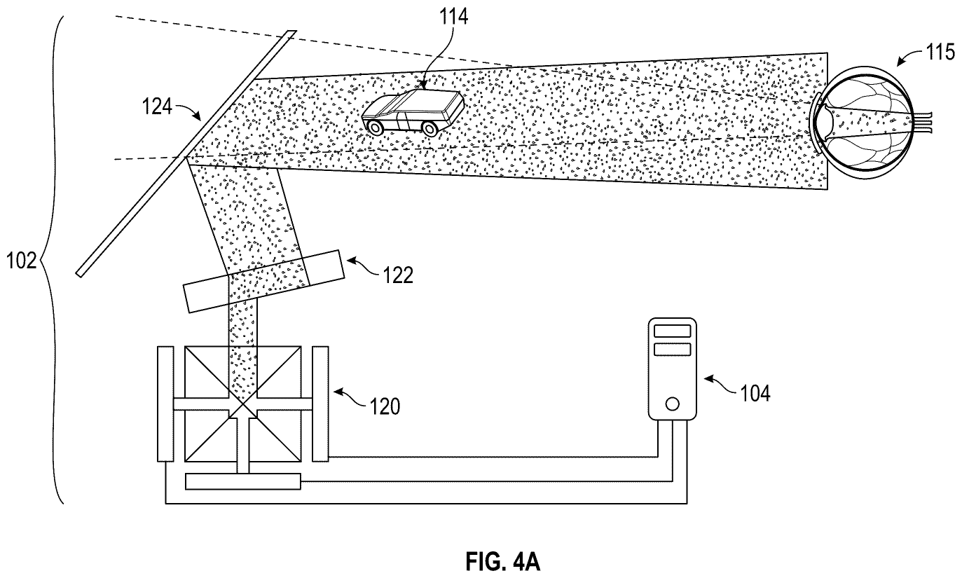

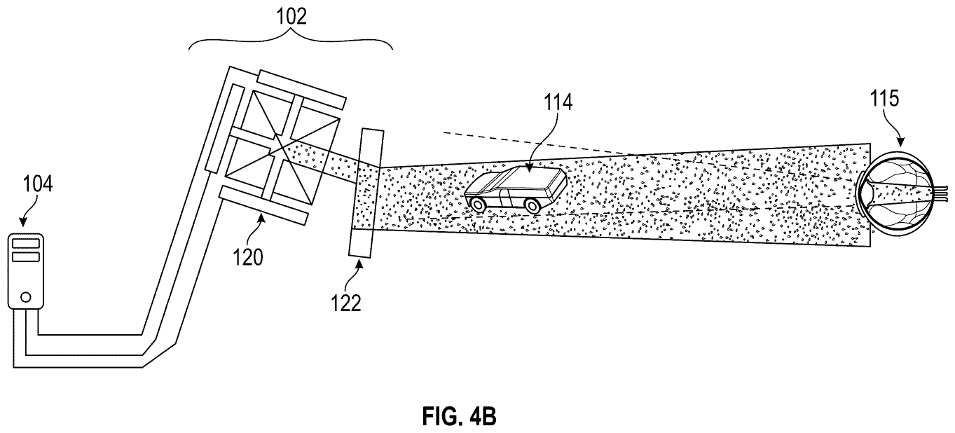

Referring now to FIGS. 4A and 4B, schematic diagrams of a holographic display device 102 configured to generate a holographic user interface 114 in accordance with one or more embodiments are shown. As illustrated, the holographic display device 102 includes a projector 120, such as a liquid crystal on silicon (LCoS) projector, and a waveguide 122 that is configured to generate a holographic user interface 114 on an eye 115 of the occupant of the vehicle. In some embodiments, the holographic display device 102 may also include one or more reflective member 124 that are configured to redirect the output of the waveguide 122 towards the eye 115 of the occupant. In exemplary embodiments, the orientation of the reflective member(s) 124 may be controlled by the processing system 104 to ensure that the output of the waveguide 122 is directed towards the eye 115 of the occupant.

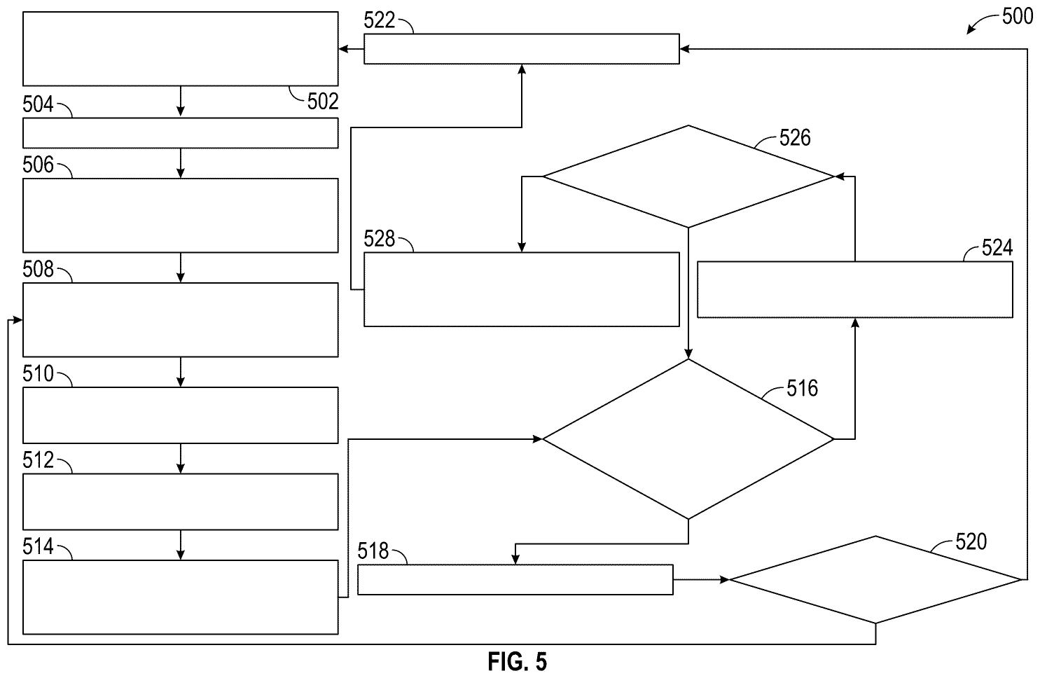

Referring now to FIG. 5, a flowchart of a method 500 for controlling the operation of a vehicle using a holographic user interface in accordance with one or more embodiments is shown. In exemplary embodiments, the method 500 is performed by a processing system of a vehicle, such as the processing system 104 shown in FIG. 2. At block 502, the method 500 includes detecting that an occupant of the vehicle performs a gesture to activate a holographic user interface (HUI). In exemplary embodiments, the processing system constantly monitors the movements of the occupants of the vehicle using one or more cameras to detect a predetermined gesture to activate the HUI. In exemplary embodiments, the predetermined gesture may be set by an operator or owner of the vehicle during the setup of the vehicle.

At block 504, the method 500 includes displaying the HUI 114. In exemplary embodiments, the HUI is displayed via one of a plurality of holographic display devices that are disposed in various locations within the vehicle. Next, at block 506, the method 500 includes detecting that the occupant of the vehicle interacts with the HUI via hand motions or gestures. In exemplary embodiments, the interaction is captured by the one or more cameras monitoring the movements of the occupants of the vehicle. At block 508, the location, trajectory vector, speed, and orientation of the interaction are determined. Next, at block 510, a movement or change to the HUI based on the interaction is determined. For example, the interaction may indicate that the user wants the vehicle to change lanes and the orientation of the vehicle in the HUI may change from going in a straight direction to moving to the left or the right. Next, an updated HUI is displayed and haptic feedback may be provided to the user at block 512. In exemplary embodiments, the haptic feedback is created using ultrasonic air pulses directed towards the hand of the occupant that is interacting with the HUI.

At block 514, the method 500 includes determining a vehicle command requested by the occupant based on the interaction. In exemplary embodiments, one or more holographic control algorithms include a mapping between various types of occupant interactions and vehicle commands that are used to determine the vehicle command requested by the occupant based on the detected interaction. In exemplary embodiments, different types of HUIs may be used to control a wide variety of vehicle systems and the holographic control algorithms include different mappings for each type of HUI. For example, a first HUI that is a scaled down representation of the vehicle may be used to control the propulsion, steering, and breaking of the vehicle and a second HUI that is a scaled down representation of a seat in the vehicle may be used to adjust the positioning of the vehicle (i.e., reclining angle) of the seat.

At decision block 516, the method 500 includes determining if the current traffic conditions allow the vehicle to perform the requested vehicle command, (i.e., in cases where the requested vehicle command is to change lanes or adjust the speed of the vehicle, a safety check is performed to determine if the requested vehicle command is safe to perform). Based on determining that it is safe to perform the requested vehicle command, the method 500 proceeds to block 518 and the vehicle is instructed to perform the requested vehicle command. After the requested vehicle command is performed, the method proceeds to decision block 520 and determines whether additional vehicle commands are detected via interaction with the HUI. If no additional vehicle commands are detected via interaction with the HUI, the method 500 proceeds to block 522 and the HUI is extinguished (i.e., the holographic display device is instructed to stop projecting the HUI). If additional vehicle commands are detected via interaction with the HUI, the method 500 returns to block 508.

Based on determining that it is not safe to perform the requested vehicle command, the method 500 proceeds to block 524 and the vehicle is instructed to wait up to a predetermined time for traffic conditions to be appropriate to perform the requested vehicle command. Next, as decision block 526, the method 500 includes determining whether the predetermined time has elapsed. If the predetermined time has not elapsed, the method 500 returns to decision block 516. Otherwise, based on a determination that the predetermined time has elapsed, the method 500 proceeds to block 528 and the HUI is modified to inform the occupant that the requested vehicle command can be performed.

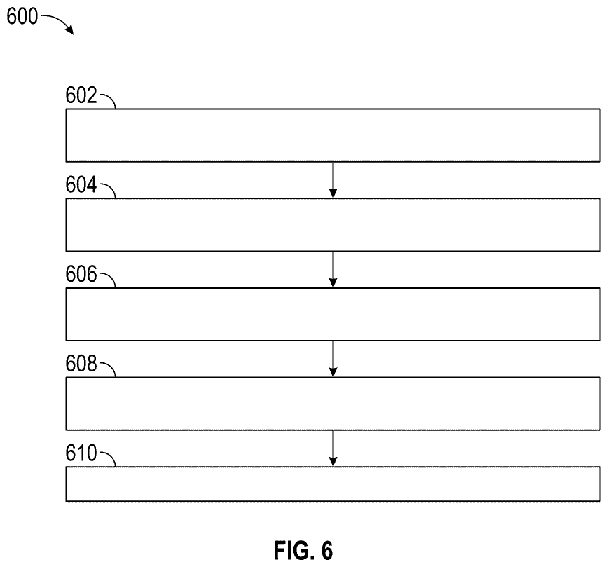

Referring now to FIG. 6, a flowchart of a method 600 for controlling the operation of a vehicle using a holographic user interface according to an embodiment is shown. The method 600 is described in reference to FIGS. 1 to 4B and may include additional steps not depicted in FIG. 6. Although depicted in a particular order, the blocks depicted in FIG. 6 can be rearranged, subdivided, and/or combined.

At block 602, the method 600 includes detecting a request, from an occupant of the vehicle, to display a holographic user interface. In one embodiment, the request is a gesture made by the occupant of the vehicle that is observed by a camera disposed in the interior of the vehicle. In another embodiment, the request is a voice command by the occupant of the vehicle that is captured by a microphone disposed in the interior of the vehicle. Next, at block 604, method 600 includes instructing a holographic display device to display a holographic user interface in response to the request. In exemplary embodiments, a type or form of the holographic user interface displayed may be determined based on the detected request. For example, a first gesture or voice command may result in the display of a holographic user interface that is a scaled down representation of the vehicle, and a second gesture or voice command may result in the display of a holographic user interface that is a menu for controlling a heating and air conditioning system of the vehicle.

At block 606, the method 600 includes detecting an interaction between the occupant and the holographic user interface. In exemplary embodiments, the interaction between the occupant and the holographic user interface is detected using one or more cameras disposed within the vehicle that monitor the movements of the hands of the occupants of the vehicle. In exemplary embodiments, haptic feedback is provided to the occupant based on the detection of the interaction.

Next, as shown at block 608, the method 600 includes identifying a desired action for the vehicle based on the interaction. In exemplary embodiments, the desired action is identified by looking up the observed interaction in a table that correlates interactions with vehicle control actions. In exemplary embodiments, the desired action is one of a modification of one or more of the direction and speed of travel of the vehicle, an adjustment to the seating position of a seat of the occupant of the vehicle, an adjustment to a heating and cooling system of the vehicle, and an adjustment to an infotainment system of the vehicle. The method 600 concludes at block 610 by instructing the vehicle to perform the desired action.

In one embodiment, when the desired action is a modification of one or more of a direction and a speed of travel of the vehicle, the method 600 includes performing a safety check for the desired action and only instructing the vehicle to perform the desired action based on a determination that the safety check has been successfully completed. For example, the desired action may be a desired lane change and the safety check may include determining whether another vehicle is present in the adjacent lane.

In exemplary embodiments, the method 600 may also include instructing the holographic display device to stop displaying the holographic user interface based on a determination that no interaction between the occupant and the holographic user interface is detected for at least a predetermined time period.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method for controlling a vehicle, the method comprising:
detecting a request, by an occupant of the vehicle, to display a holographic user interface;
instructing a holographic display device to display the holographic user interface;
detecting an interaction between the occupant and the holographic user interface;
identifying a desired action for the vehicle based on the interaction; and
instructing the vehicle to perform the desired action.

2. The method of claim 1, wherein the desired action is a modification of one or more of a direction and a speed of travel of the vehicle and wherein the method further comprises performing a safety check for the desired action and only instructing the vehicle to perform the desired action based on a determination that the safety check has been successfully completed.

3. The method of claim 1, further comprising instructing the holographic display device to stop displaying the holographic user interface based on a determination that no interaction between the occupant and the holographic user interface is detected for at least a predetermined time period.

4. The method of claim 1, wherein the holographic user interface is a scaled down representation of the vehicle.

5. The method of claim 1, further comprising providing haptic feedback to the occupant based on the detection of the interaction.

6. The method of claim 1, wherein the request is a gesture made by the occupant of the vehicle that is observed by a camera disposed in an interior of the vehicle.

7. The method of claim 1, wherein the interaction is a gesture made by the occupant of the vehicle that is observed by a camera disposed in an interior of the vehicle.

8. The method of claim 1, wherein the request is a voice command by the occupant of the vehicle that is captured by a microphone disposed in an interior of the vehicle.

9. The method of claim 1, wherein the desired action is one of an adjustment to a seating position of a seat of the occupant of the vehicle, an adjustment to a heating and cooling system of the vehicle, and an adjustment to an infotainment system of the vehicle.

10. A method for controlling an autonomous vehicle, the method comprising:
detecting a request, by an occupant of the autonomous vehicle, to display a holographic user interface;
instructing a holographic display device to display the holographic user interface comprising a scaled down representation of the autonomous vehicle;
detecting an interaction between the occupant and the holographic user interface;
identifying a desired action for the autonomous vehicle based on the interaction wherein the desired action is a modification of one or more of a direction and a speed of travel of the autonomous vehicle;
based on a determination that the autonomous vehicle can safely perform the desired action, instructing the autonomous vehicle to perform the desired action; and
based on a determination that the autonomous vehicle can not safely perform the desired action, providing feedback to the occupant of the autonomous vehicle that the desired action can not be performed.

11. The method of claim 10, further comprising instructing the holographic display device to stop displaying the holographic user interface based on a determination that no interaction between the occupant and the holographic user interface is detected for at least a predetermined time period.

12. The method of claim 10, wherein the feedback is a haptic feedback provided to the occupant.

13. The method of claim 10, wherein the feedback is a change made to an appearance of the holographic user interface.

14. The method of claim 10, wherein the request is a gesture made by the occupant of the autonomous vehicle that is observed by a camera disposed in an interior of the autonomous vehicle.

15. The method of claim 10, wherein the interaction is a gesture made by the occupant of the autonomous vehicle that is observed by a camera disposed in an interior of the autonomous vehicle.

16. The method of claim 10, wherein the request is a voice command by the occupant of the autonomous vehicle that is observed by a microphone disposed in an interior of the autonomous vehicle.

17. A vehicle comprising:
a plurality of sensors configured to monitor a movement of an occupant of the vehicle;
a holographic display device configured to display a holographic user interface; and
a processing system configured to receive data from the plurality of sensors, wherein the processing system is configured to execute a computer program that includes instructions to:
detect a request, by the occupant of the vehicle, to control a system of the vehicle;
instruct, based on the request, the holographic display device to display the holographic user interface, wherein a form of the holographic user interface is determined based on the system of the vehicle to be controlled;
detect, via one or more of the plurality of sensors, an interaction between the occupant and the holographic user interface;
identify a desired action for the system of the vehicle based on the interaction; and
instruct the vehicle to perform the desired action.

18. The vehicle of claim 17, wherein the system of the vehicle is one of a drive system of the vehicle, an infotainment system of the vehicle, and a heating and cooling system of the vehicle.

19. The vehicle of claim 18, wherein the request is a gesture made by the occupant of the vehicle that is observed by a camera disposed in an interior of the vehicle and wherein the system of the vehicle is determined based on a type of the gesture.

20. The vehicle of claim 17, wherein the desired action is a modification of one or more of a direction and a speed of travel of the vehicle and wherein the instructions further comprise instructions to perform a safety check for the desired action and only instructing the vehicle to perform the desired action based on a determination that the safety check has been successfully completed.
